(19) United States
(12) Patent Application Publication
(10) Pub. No.: US 2012/0037354 A1
(43) Pub. Date: Feb. 16, 2012

(54) Systems and Methods for Downhole OFDM Communications

(76) Inventors: Robert H. McCoy, Talala, OK (US); Gordon L. Besser, Claremore, OK (US); Stewart D. Reed, Owasso, OK (US); Dustin B. Campbell, Tulsa, OK (US); Dick L. Knox, Claremore, OK (US)

(21) Appl. No.: 12/855,010

(22) Filed: Aug. 12, 2010

(51) Int. Cl. H04L 29/02; G01V 3/00

(52) U.S. Cl. 166/65.1; 340/855.3

(57) ABSTRACT

Systems and methods for reliably communicating data at high data rates between surface and downhole equipment over a power cable by multiplexing data, modulating the data onto orthogonal carrier frequencies, communicating the modulated carrier signals over the power cable, recovering of the modulated signals, and demodulating the data stream from the recovered signal. One embodiment comprises a system that includes surface equipment connected by a power cable to an ESP system that has a gauge package connected to it. The gauge package uses a high-temperature DSP to perform the data processing associated with OFDM communications.

### BACKGROUND

1. Field of the Invention

The invention relates to systems for communication between surface and downhole equipment in a well, and more particularly to systems and methods for reliably communicating data at high rates between surface and downhole equipment over a power cable using orthogonal frequency division multiplexing (OFDM).

2. Related Art

Often, in the production of oil from subterranean wells, it is necessary to position equipment such as electric submersible pump (ESP) systems in the wells. The pump systems are operated to push oil or oil mixtures out of the well. Various gauges and sensors may be incorporated into or coupled to the pump system to provide information relating to the pump system's environment or other operating conditions.

In order to make use of the information obtained through the gauges and sensors, it is necessary to be able to communicate this information from these components, which are positioned downhole in the well, to the surface of the well where display, data collection and control systems for the ESP system are located. Most conventional sensor systems that are used with ESP systems utilize low frequency (e.g., 5-10 baud) current loop modulation to communicate data to the control systems. This current loop may be implemented over the cable that is used to provide power from the surface equipment to the ESP system. The primary function of the power cable in one embodiment is to supply 3-phase AC power from the surface to the AC motor of the ESP system. Systems in which data is communicated on the power cable may be referred to as “coms-on” systems.

Conventional coms-on systems have a number of disadvantages. One of the disadvantages is the low data rate (5-10 baud) that is achievable with a DC current loop. This may significantly limit the system's ability to monitor borehole conditions and to react to these conditions. Another disadvantage is that, because power is typically supplied to the ESP system over a three-phase cable with the direct current of the current loop is impressed on all three phases of the cable, if one of these phases is grounded, the current loop is shorted and communications are prevented. Current loop communications are also subject to noise from the pump motor, as well as cable reflections, which may degrade the data. Another disadvantage is that systems that use DC current loops for communication typically also provide DC current to the auge package, which may promote corrosion.

It would therefore be desirable to provide systems and methods for communicating between surface and downhole equipment in a well that reduce or eliminate one or more of these disadvantages.

### SUMMARY OF THE INVENTION

This disclosure is directed to systems and methods for reliably communicating data at high data rates between surface and downhole equipment over a power cable. In particular, the systems and methods provide for the multiplexing of data, modulation of the data onto orthogonal carrier frequencies, communication of the modulated carrier signals over the power cable, recovery of the modulated signals, and demodulation of the data stream from the recovered signal.

One embodiment comprises a system for communication between downhole equipment and surface equipment over a power cable using orthogonal frequency division multiplexing (OFDM). The system includes downhole equipment positioned within a wellbore, surface equipment positioned outside the wellbore and a power cable coupled between the downhole equipment and the surface equipment. The surface equipment provides power to the downhole equipment over the power cable. The downhole equipment is configured to communicate with the surface equipment by transmission of multiple modulated orthogonal carrier frequencies over the power cable, where the carrier frequencies simultaneously carry multiple, different data streams.

In one embodiment, the downhole equipment consists of an electric submersible pump (ESP) system that has a gauge package connected to the motor of the ESP system. The power cable provides three-phase power to the motor. The gauge package is electrically connected to the Wye point of the motor to receive power and to communicate over the power cable. The gauge package includes one or more sensors and a digital signal processor which is capable of operating in high temperatures and pressures that exist downhole (e.g., temperatures of at least 85 degrees C. and pressures of at least 250 psi). The processor is configured to perform formatting, error checking and correction, multiplexing, demultiplexing, interleaving, modulation, demodulation, Fast Fourier Transforms, inverse Fast Fourier Transforms, and other functions that may be involved in the implementation of OFDM communications. The surface equipment and downhole equipment may be configured to communicate unidirectionally or bidirectionally. The system may include two or more transceivers, and the transceivers may be located at different positions within the wellbore, where they may be electrically coupled to the ESP power cable.

An alternative embodiment comprises downhole equipment such as an ESP gauge package that is configured to communicate over a power cable using orthogonal frequency division multiplexing (OFDM). The downhole equipment is configured to be connected to a downhole power cable and to receive power over the cable. The downhole equipment includes a transceiver configured to communicate by transmission of multiple modulated orthogonal carrier frequencies over the power cable, where the carrier frequencies simultaneously carry multiple, different data streams. The downhole equipment may include a digital signal processor which is capable of operating in high-temperature and high-pressure conditions. The processor may perform formatting, error checking and correction, multiplexing, demultiplexing, interleaving, modulation, demodulation, Fast Fourier Transforms, inverse Fast Fourier Transforms, and other functions that may be involved in the implementation of OFDM communications. The downhole equipment may be configured to communicate unidirectionally or bidirectionally.

Another alternative embodiment comprises a method for communicating over a power cable with downhole equipment that is positioned within a wellbore. The method may be implemented in the downhole equipment and may include the steps of generating data, formatting the data into multi-bit symbols and, for each symbol, modulating each bit of the symbol onto a different one of a plurality of orthogonal carrier frequencies and then simultaneously impressing the resulting modulated orthogonal carrier frequencies on a power cable which is connected to the downhole equipment. The method may alternatively comprise detecting multiple modulated orthogonal carrier frequencies on the power cable, demodulating a bit from each of the multiple modulated orthogonal carrier frequencies, and reconstructing a multi-bit symbol from the demodulated bits. The methods may include formatting data, error checking and correction, multiplexing, demultiplexing, interleaving, modulation, demodulation, Fast Fourier Transforms, inverse Fast Fourier Transforms, and performing other functions that may be involved in the implementation of OFDM communications.

Numerous other embodiments are also possible.

### BRIEF DESCRIPTION OF THE DRAWINGS

Other objects and advantages of the invention may become apparent upon reading the following detailed description and upon reference to the accompanying drawings.

FIG. 1 is a diagram illustrating an exemplary pump system in accordance with one embodiment.

FIG. 2 is a functional block diagram illustrating the structure of an exemplary gauge package transceiver in accordance with one embodiment.

FIG. 3 is a functional block diagram illustrating the software components implemented in a DSP in accordance with an exemplary embodiment.

FIG. 4 is a flow diagram illustrating a method by which an exemplary embodiment transmits data using OFDM.

FIG. 5 is a flow diagram illustrating the method by which data transmitted using OFDM is received in an exemplary embodiment.

FIG. 6 is a functional block diagram illustrating the structure of a surface transceiver in accordance with an exemplary embodiment.

While the invention is subject to various modifications and alternative forms, specific embodiments thereof are shown by way of example in the drawings and the accompanying detailed description. It should be understood, however, that the drawings and detailed description are not intended to limit the invention to the particular embodiment which is described. This disclosure is instead intended to cover all modifications, equivalents and alternatives falling within the scope of the present invention as defined by the appended claims.

### DETAILED DESCRIPTION OF PREFERRED EMBODIMENTS

One or more embodiments of the invention are described below. It should be noted that these and any other embodiments described below are exemplary and are intended to be illustrative of the invention rather than limiting.

As described herein, various embodiments of the invention comprise systems and methods for reliably communicating data at high data rates between surface and downhole equipment over a power cable using orthogonal frequency division multiplexing (OFDM).

The present systems and methods utilize high-temperature semiconductor devices (e.g., DSP's) to provide the computational power necessary to implement OFDM communications in the harsh conditions that exist downhole in a wellbore. In one embodiment, the surface equipment includes a controller such as a variable speed drive that provides three-phase power over a power cable to an electric submersible pump (ESP) system. A gauge package is connected to the motor of the ESP system. The gauge package receives power from the motor, and is coupled to the Wye point of the motor so that OFDM signals can be transmitted to and received from the surface equipment via the power cable. The gauge package incorporates a DSP that receives data from various sensors and generates corresponding OFDM signals that are transmitted to the surface equipment. The DSP also decodes received OFDM signals that may contain data requests, commands, or other information.

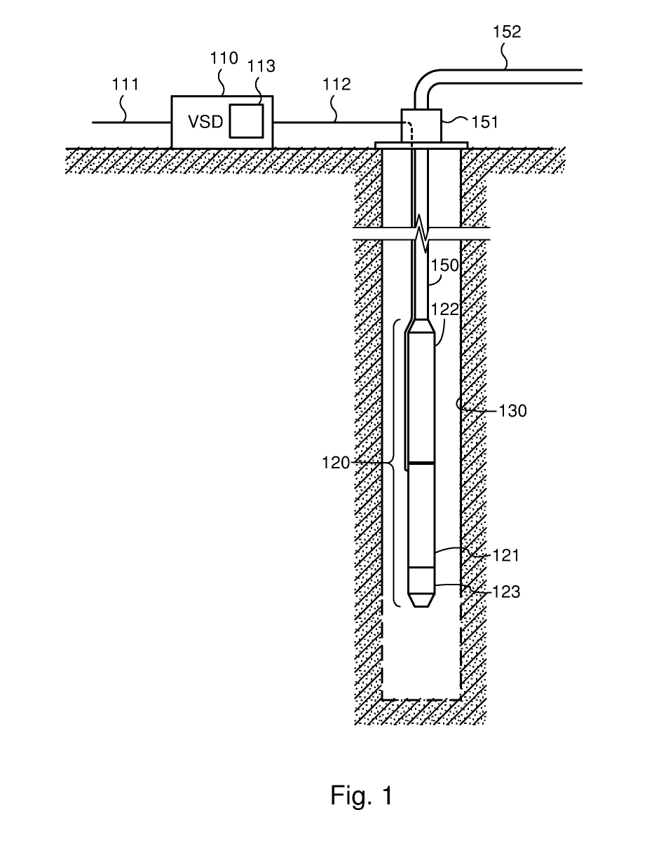

Referring to FIG. 1, a diagram illustrating an exemplary pump system in accordance with one embodiment of the present invention is shown. A wellbore 130 is drilled into an oil-bearing geological structure and is cased. The casing within wellbore 130 is perforated at the lower end of the well to allow oil to flow from the formation into the well. Electric submersible pump 120 is coupled to the end of tubing string 150, and the pump and tubing string are lowered into the wellbore to position the pump in a producing portion of the well (as indicated by the dashed lines at the bottom of the wellbore). A variable speed drive 110 which is positioned at the surface is coupled to pump 120 by power cable 112, which runs down the wellbore along tubing string 150.

Pump 120 includes an electric motor section 121 and a pump section 122. A gauge package 123 is attached to the bottom of motor section 121. (Pump 120 may include various other components which will not be described in detail here because they are well known in the art and are not important to a discussion of the invention.) Motor section 121 is operated to drive pump section 122, which actually pumps the oil through the tubing string and out of the well.

In this embodiment, motor section 121 uses an induction motor which is driven by variable speed drive 110. Variable speed drive 110 receives AC (alternating current) input power from an external source such as a generator (not shown in the figure) via input line 111. Drive 110 rectifies the AC input power and then produces three-phase AC output power that is suitable to drive motor section 121 of pump 120. This output power is provided to motor section 121 via power cable 112.

Drive 110 and gauge package 123 include transceivers (113 and 123, respectively) for communicating information between the drive and the pump system. Gauge package 123 includes sensors that measure various physical parameters that need to be communicated to surface equipment such as drive 110, and drive 110 or other surface equipment may generate control information that needs to be communicated to the pump system to control its operation, or to the gauge package to request information. In this embodiment, transceivers 113 and 123 are each coupled to power cable 112 and communicate over the power cable using multiple, orthogonal high frequency carrier signals. The stream of data to be transmitted is split into multiple, different streams which are modulated onto the carrier frequencies, transformed by an inverse Fast Fourier Transform, and then transmitted over the power cable. The resulting signal does not interfere with the transmission of power (i.e., drive signals) from drive 110 to pump system 120.

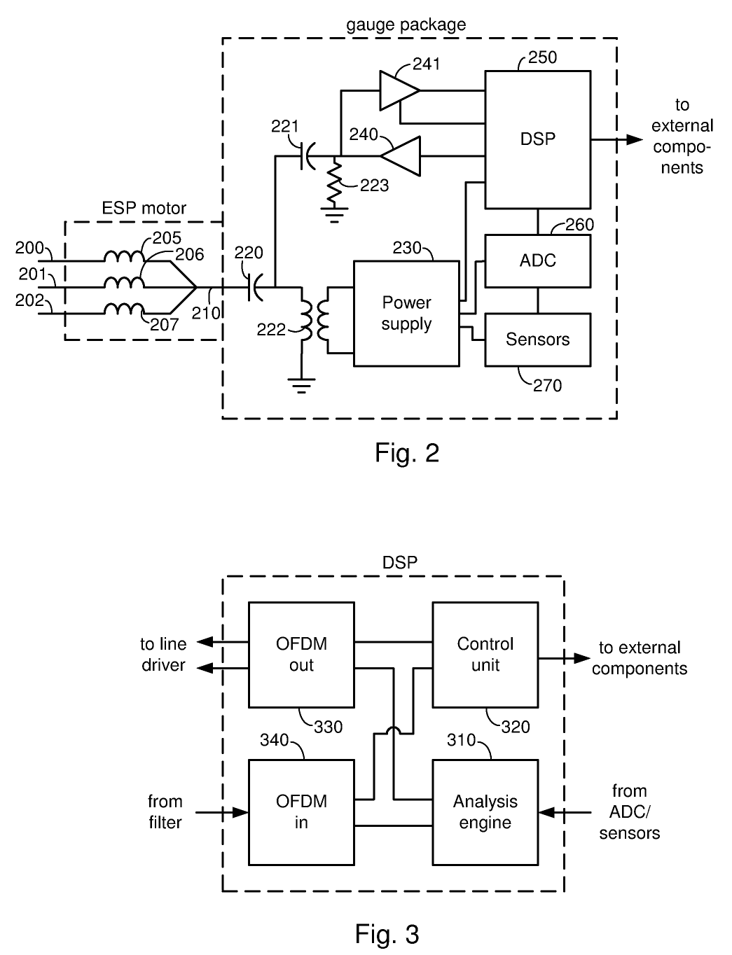

Referring to FIG. 2, a functional block diagram illustrating the structure of an exemplary gauge package transceiver is shown. As noted above, the gauge package is attached to the lower end of the pump system's motor. The motor receives three-phase power from the three conductors of the power cable. The gauge package is coupled to the motor at the “Wye” point (or “Y” point) 210 of the motor, where windings 205-207 are connected. High-voltage capacitor 220 couples transformer 222 to Wye point 210. Transformer 222 drives power supply 230, which is configured to rectify the output of the transformer and generate DC power at the specific voltages needed by the various components of the gauge package. This AC power system is similar to the power system described in U.S. Patent Application Pub. No. 2009/0021393, entitled “System and Method for AC Power Downhole Gauge”.

The gauge package transceiver includes a microprocessor such as digital signal processor (DSP) 250, an analog-to-digital converter (ADC) 260, and one or more sensors 270. Sensors 270 may include various different types of sensors that are designed to measure downhole environmental conditions, such as downhole temperature and pressure, pump system operating conditions, such as motor temperature, intake pressure and temperature, discharge pressure and temperature, Wye point voltage, motor/pump vibration, or any other relevant condition. Sensors 270 typically generate analog output signals, so analog-to-digital converter 260 is provided to convert these analog signals into corresponding digital signals so that they can be processed by DSP 250.

DSP 250 is primarily responsible for performing the data processing, control and communication functions of the gauge package. In particular, DSP 250 functions as a transceiver, processing the data received from sensors 270 through ADC 260 and generating corresponding OFDM signals that will be transmitted from the gauge package through the power cable to the surface equipment. Similarly, DSP 250 receives OFDM signals from the surface equipment through the power cable, detects, demodulates and decodes the data therein, and processes the resulting data. DSP 250 is coupled to a transmitter 240 which drives the generated OFDM signals onto the power cable, as well as a receiver 241 which detects, amplifies and filters OFDM signals received from the power cable. The received information could be used to drive relays, motors, message rates, calibration, software configurations, etc. Transmitter 240 and receiver 241 are coupled to the input of transformer 222 through a second capacitor 221 and are coupled through a termination resistor 223 to ground.

In one embodiment, the components of the gauge package are designed to fit into a housing that is no more than 4.5 inches in diameter and 48 inches long. This housing is configured to be bolted to the bottom of an ESP motor after the gauge electronics are connected to the Wye point of the motor as described above. It should be noted that the components of the gauge package, including DSP 250, must be capable of performing the substantial computational functions of the OFDM transceiver in the extremely harsh conditions that exist downhole. For instance, downhole temperatures may reach 200 degrees C., and downhole pressures may reach 5000 psi. It is contemplated that the components of the gauge package should be capable of operating in temperatures of at least 85 degrees C. and pressures of at least 250 psi, although the system is not necessarily limited to these conditions.

Conventional semiconductor devices are not capable of operating in very high temperature and pressure conditions, so communications with downhole equipment have conventionally utilized current loops, which are more easily implemented in hardware. The recent development of high-temperature DSP's such as the TI TMS320F28335, however, has made available sufficient processing power in the gauge package to support the complex computations required for OFDM communications. It may be desirable, even when using a high-temperature device, to operate the device at a reduced clock speed to aid in the dissipation of heat from the device.

Referring to FIG. 3, a functional block diagram illustrating the software components implemented in the DSP in an exemplary embodiment is shown. Control unit 320 manages the functions of the DSP. This may, for example, involve managing data flow among the software components, managing communications to and from the gauge package, and managing the functions performed by the DSP.

In this embodiment, the DSP executes an analysis engine 310 which is configured to receive raw data from the sensors in the gauge package, process the data, and potentially perform analyses on the data. Analysis engine 310 may be designed to simply pass sensor data through to the OFDM output component for transmission to the surface equipment, or it may be designed to perform one or more analyses on the data. These analyses may be pre-programmed, or they may be performed in response to requests or controls that are received from the surface equipment.

OFDM engines 330 and 340 are configured to provide an interface for communication with the surface equipment. In regard to outgoing transmissions, OFDM output engine 330 receives data from analysis engine 310 and/or control unit 320 and generates outgoing OFDM signals that embody the data. Conversely, OFDM input engine 340 receives incoming OFDM signals and reconstructs the data that is embodied in these signals. This data is normally forwarded to control unit 320, although it could be provided to analysis engine 310 for use in the processing of sensor data.

As described briefly above, OFDM is a technology that transmits multiple signals simultaneously over a transmission path. In this case, the transmission path is the power cable that connects the motor controller (the power source) to the ESP system and gauge package. Each of the multiple signals is a modulated carrier frequency or “subcarrier”. Since all of these signals are transmitted over the same transmission path, they can alternatively be viewed as a single signal that is the sum of all of the modulated carrier frequencies. In the exemplary embodiment described herein, the OFDM transceiver generates this summed signal, rather than independently generating each of the individual modulated carrier frequencies.

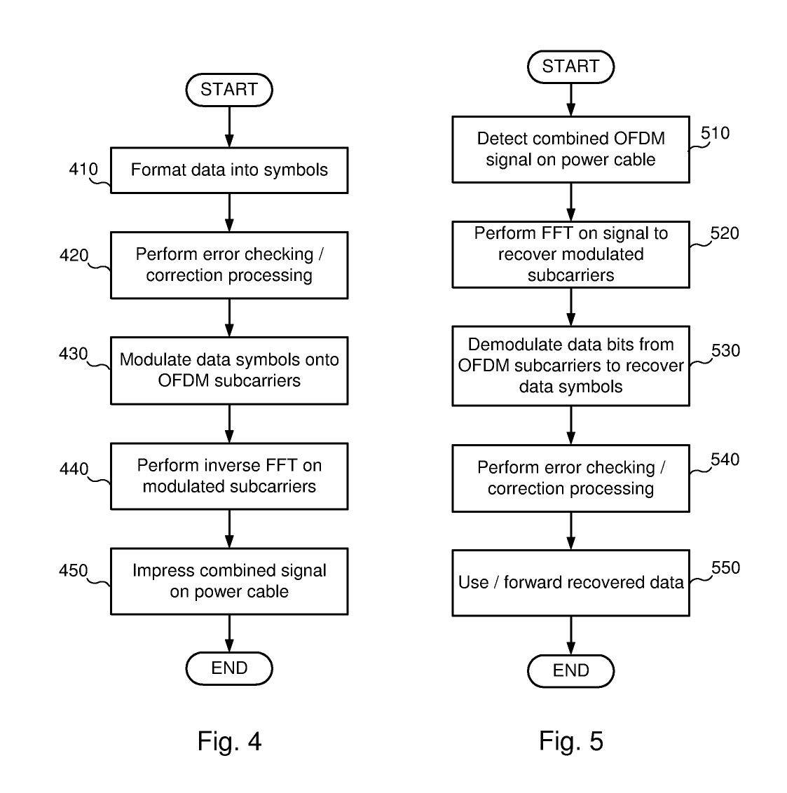

Referring to FIG. 4, a flow diagram illustrating the method by which this exemplary embodiment transmits data using OFDM is shown. As depicted in this figure, data is received and formatted into multi-bit data symbols that will be transmitted (410). This may simply consist of splitting a single serial data stream into multiple parallel streams. Error correction such as a cyclic redundancy check (CRC) or convolutional encoding may be performed on the data symbols (420), and corresponding error-correction information may be contained in the data symbols in addition to the payload (e.g., sensor data). The data symbols may also be scrambled, or they may be interleaved to spread possible errors. The bits of the symbols are then modulated onto the different carrier frequencies (430). An inverse Fast Fourier Transform (IFFT) is performed on the carrier frequencies (440) to produce an OFDM signal that is impressed onto the power cable (450).

Referring to FIG. 5, a flow diagram is shown to illustrate the method by which data transmitted using OFDM is received in the exemplary embodiment. As shown in the figure, the OFDM signal on the power cable is detected (510), and a Fast Fourier Transform (FFT) is performed on the signal (520). The FFT recovers the modulated carrier frequencies, from which the symbols can be demodulated (530). The symbols are de-interleaved if necessary, and error-correction decoding is performed (540). This produces the original data symbols, which can be processed or otherwise used by the receiving device (550).

The OFDM transmission scheme distributes the data over a large number of subcarriers that are spaced apart at precise frequencies. More specifically, the subcarriers are spaced apart such that the first nulls occur at the subcarrier frequencies on the adjacent channels. Consequently, the modulation on one channel does not produce intersymbol interference in the adjacent channels. This orthogonality also prevents the demodulator for each subcarrier in the receiver from seeing frequencies other than its own. The reduced interference allows the carrier frequencies to be more closely spaced, and consequently provides high spectral efficiency, or bandwidth efficiency. The greater the spectral efficiency, the more data can be transmitted in a given bandwidth in the presence of noise. (The maximum data rates will vary, depending upon factors such as the modulation method that is used.)

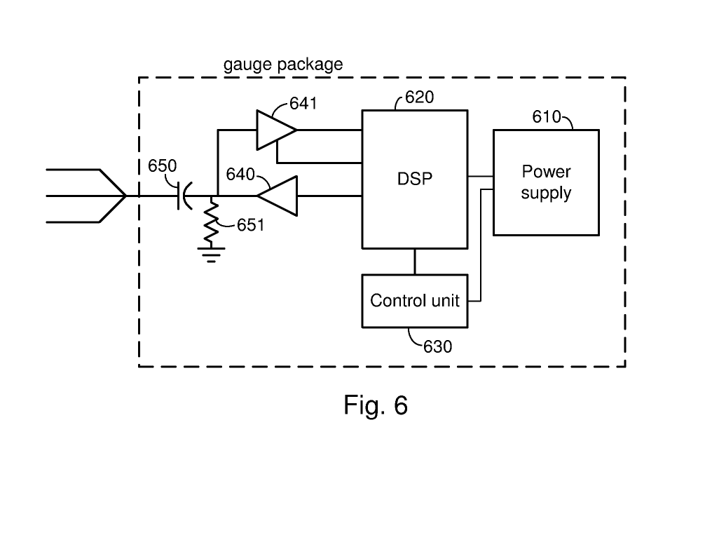

While FIG. 2 depicts a downhole transceiver, the structure of an OFDM transceiver coupled to the surface equipment is very similar. The structure of an exemplary surface transceiver is illustrated in the functional block diagram of FIG. 6. This transceiver does not have to draw power from the power cable. Instead, power supply 610 is driven by an external AC source and converts this power to the voltages needed by the components of the transceiver. The transceiver includes a DSP 620 and a control unit 630. Control unit 630 controls the data that is provided to DSP 620 for transmission, as well as data that has been received by the transceiver over the power cable. This data may be communicated to a user, an external control system, or other external equipment. DSP 620 performs the data processing, control and communication functions of the transceiver, as described in connection with FIGS. 4 and 5. DSP 620 is coupled to a transmitter 640, which is capacitively coupled to the power cable and impresses generated OFDM signals onto the power cable. DSP 620 is also coupled to a receiver 641 that detects, amplifies and filters OFDM signals received over the power cable.

It should be noted that the OFDM communications described above comprise a physical data transport layer. A link layer protocol may be implemented to provide convenient means for multiple devices to access the OFDM communication mechanism. In one embodiment, a medium access control (MAC) layer and an internet protocol convergence layer are implemented. This would facilitate communications between devices that could include not only the surface equipment and ESP gauge package, but also intermediately spaced gauges. The different devices could be addressable so that communications could be directed to them individually (Peer-to-peer or master-slave or spy monitor), and individual devices could even be used as relays to communicate data between other devices.

The OFDM transceivers may have widely varying characteristics in different embodiments. These characteristics may include subcarrier frequencies, number of subcarriers, type of modulation, type of error correction, use of scrambling or interleaving, It is contemplated that an exemplary embodiment would use narrow band carriers in the 20-100 khz range, which is above the noise band for a typically ESP system. The OFDM mechanism in this embodiment could, for example, use 97 subcarriers, although alternative embodiments could use many more or as few as 8 or 16 subcarriers. The system could use quadrature phase shift (QPSK) modulation. With Viterbi error correction of 1.5, such a system could achieve a data rate of 56 Kbps (as compared to a conventional DC current loop data rate of 5-10 bps).

As mentioned above, the present systems may have a number of advantages over prior art systems for communication between surface and downhole equipment. For instance, the present systems provide a substantially greater data transfer rate than conventional systems that utilize a DC current loop to transmit data. The present systems can therefore transmit data in realtime and allow rapid responses to changing downhole operating conditions. Another advantage is that the present systems continue to operate when one of the phases of the power cable is grounded, whereas a conventional system using a DC current-loop will fail in this circumstance. Further, error correction that is possible with the present systems avoids data degradation that may result in conventional systems from pump motor noise and cable reflections. Still further, the elimination of the DC current loop eliminates a cause of corrosion that may, over time, degrade data transmissions.

It should be noted that the foregoing disclosure describes one exemplary embodiment, and that the specific structures, characteristics and features may vary in alternative embodiments. For example, the system may implement OFDM communication using more or less than 48 subcarriers, the subcarriers may be in a range above or below the 20-100 kHz range, the data symbols may or may not include error correction, interleaving or redundancy, the data may be encoded on the subcarriers using any suitable type of modulation (e.g., DPSK, QPSK, 8PSK, and 16PSK, QAM, FSK or others). Further, the OFDM transceivers may be implemented in ESP systems, ESP gauge packages, intermediately positioned gauge packages or other downhole equipment. The OFDM transceivers may be positioned in only two locations (e.g., incorporated into surface equipment and an ESP system), or they may be incorporated into three or more locations (e.g., incorporated into surface equipment, an ESP system and intermediately positioned gauge packages). The OFDM transceivers may be bidirectional (where each is configured to both transmit and receive) or unidirectional (where one is a transmitter and one is a receiver). Other variations may be apparent to a person of ordinary skill in the art upon reading the present disclosure.

It should also be noted that, while the systems described above comprise coms-on systems, the described OFDM communication techniques may be implemented in systems that do not implement communications over the power cable. These alternative embodiments may implement OFDM communications over a dedicated communications cable between the downhole equipment and the surface equipment.

Those of skill will appreciate that the various illustrative logical blocks, modules, circuits, and algorithm steps described in connection with the embodiments disclosed herein may be implemented as electronic hardware, computer software (including firmware) or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with DSP's, application specific integrated circuits (ASICs), field programmable gate arrays (FPGAs), general purpose processors or other logic devices, discrete gates or transistor logic, discrete hardware components, or any combination thereof designed to perform the functions described herein. A general purpose processor may be any conventional processor, controller, microcontroller, state machine or the like. A processor may also be implemented as a combination of computing devices, e.g., a combination of a DSP and a microprocessor, a plurality of microprocessors, one or more microprocessors in conjunction with a DSP core, or any other such configuration.

The steps of the methods and algorithms described in connection with the embodiments disclosed herein may be embodied directly in hardware, in software (program instructions) executed by a processor, or in a combination of the two. Software may reside in RAM memory, flash memory, ROM memory, EPROM memory, EEPROM memory, registers, hard disk, a removable disk, a CD-ROM, or any other form of storage medium known in the art.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein and recited within the following claims.

What is claimed is:

1. A system for communication between downhole equipment and surface equipment over a power cable, the system comprising:
downhole equipment positioned downhole within a wellbore;
surface equipment positioned outside the wellbore; and
a power cable coupled between the downhole equipment and the surface equipment;
wherein the power cable conveys power from a power supply which is coupled to the surface equipment to the downhole equipment; and
wherein the downhole equipment is configured to communicate with the surface equipment by orthogonal frequency division multiplexed (OFDM) transmission of multiple modulated orthogonal carrier frequencies over the power cable, wherein the carrier frequencies simultaneously carry multiple, different data streams.

2. The system of claim 1, wherein the downhole equipment comprises an electric submersible pump (ESP) system.

3. The system of claim 2, wherein the downhole equipment comprises a gauge package which is connected to a motor of the ESP system.

4. The system of claim 3, wherein the power cable comprises a three-phase cable which is connected to the motor, and wherein the gauge package is electrically connected to a Wye point of the motor.

5. The system of claim 3, wherein the gauge package includes a microprocessor which is capable of operating in temperatures of at least 85 degrees C. and pressures of at least 250 psi.

6. The system of claim 5, wherein the microprocessor comprises a digital signal processor (DSP).

7. The system of claim 3, wherein the gauge package includes one or more sensors.

8. The system of claim 1, wherein the downhole and surface equipment are configured to communicate data at a rate of at least 1000 bits per second.

9. The system of claim 1, wherein the downhole equipment and the surface equipment each includes an OFDM transceiver that is configured to both transmit and receive OFDM communications.

10. The system of claim 1, wherein one of the downhole equipment and the surface equipment each includes an OFDM transmitter and the other includes an OFDM receiver.

11. The system of claim 1, wherein each of the multiple modulated orthogonal carrier frequencies is configured to simultaneously carry a different unique of a single data symbol, wherein the symbol contains payload information and error-correction information.

12. The system of claim 1, wherein the downhole equipment comprises first equipment positioned at a first location within the wellbore and second equipment positioned at a second location within the wellbore, wherein the first equipment, the second equipment and the surface equipment each includes an OFDM transceiver which is individually addressable by the other OFDM transceivers.

13. An apparatus for downhole communications comprising:
downhole equipment; and
a transceiver coupled to the downhole equipment;
wherein the downhole equipment and the transceiver are configured to be coupled to a power cable that conveys power to the downhole equipment from a power supply which is external to the downhole equipment; and
wherein the transceiver is configured to communicate with the surface equipment by orthogonal frequency division multiplexed (OFDM) transmission of multiple modulated orthogonal carrier frequencies over the power cable, wherein the carrier frequencies simultaneously carry multiple, different data streams.

14. The apparatus of claim 13, wherein the downhole equipment comprises an electric submersible pump (ESP) system.

15. The apparatus of claim 14, wherein the downhole equipment comprises a gauge package which is connected to a motor of the ESP system.

16. The apparatus of claim 15, wherein the power cable comprises a three-phase cable which is connected to the motor, and wherein the gauge package is electrically connected to a Wye point of the motor.

17. The apparatus of claim 15, wherein the gauge package includes a microprocessor which is capable of operating in temperatures of at least 85 degrees C. and pressures of at least 250 psi.

18. The apparatus of claim 17, wherein the microprocessor comprises a digital signal processor (DSP).

19. The apparatus of claim 15, wherein the gauge package includes one or more sensors.

20. The apparatus of claim 13, wherein the downhole and surface equipment are configured to communicate data at a rate of at least 1000 bits per second.

21. The apparatus of claim 13, wherein the downhole equipment is configured to both transmit and receive OFDM communications over the power cable.

22. A method for communicating with downhole equipment positioned within a wellbore over a power cable, the method comprising:
generating data in downhole equipment positioned within a wellbore;
formatting the data into multi-bit symbols; and
for each symbol, modulating each bit of the symbol onto a different one of a plurality of orthogonal carrier frequencies and then simultaneously impressing the resulting modulated orthogonal carrier frequencies on a power cable which is connected to the downhole equipment.

23. The method of claim 22, further comprising detecting the modulated orthogonal carrier frequencies at surface equipment which is connected to the power cable, demodulating the bits of the symbols from the modulated orthogonal carrier frequencies, and reconstructing the data from the demodulated bits.

24. The method of claim 23, further comprising:
performing an inverse Fast Fourier Transform (IFFT) on the modulated orthogonal carrier frequencies to produce a combined OFDM signal prior to impressing the modulated orthogonal carrier frequencies on the power cable, wherein impressing the modulated orthogonal carrier frequencies on the power cable comprises impressing the combined OFDM signal on the power cable;
wherein detecting the modulated orthogonal carrier frequencies comprises detecting the combined OFDM signal;
further comprising performing a Fast Fourier Transform (FFT) on the combined OFDM signal to recreate the modulated orthogonal carrier frequencies prior to demodulating the bits of the symbols from the modulated orthogonal carrier frequencies.

25. The method of claim 22, further comprising performing an inverse Fast Fourier Transform (IFFT) on the modulated orthogonal carrier frequencies to produce a combined OFDM signal prior to impressing the modulated orthogonal carrier frequencies on the power cable, wherein impressing the modulated orthogonal carrier frequencies on the power cable comprises impressing the combined OFDM signal on the power cable.

26. A method for communicating with downhole equipment positioned within a wellbore over a power cable, the method comprising:
detecting multiple modulated orthogonal carrier frequencies on a power cable which is connected to downhole equipment positioned within a wellbore, wherein the detecting is performed by the downhole equipment;
for each of the multiple modulated orthogonal carrier frequencies, demodulating a corresponding bit; and
reconstructing a multi-bit symbol from the demodulated bits.

27. The method of claim 26, further comprising performing error correction on the reconstructed symbol.
